(19) United States
(12) Patent Application Publication
(10) Pub. No.: US 2008/0073807 A1
(43) Pub. Date: Mar. 27, 2008

(54) Method of forming a vehicle trim component

(75) Inventors: Glenn A. Cowelchuk, Chesterfield Twp., MI (US); Gail Miciuda, Grosse Pointe Park, MI (US)

Correspondence Address: INTERNATIONAL AUTOMOTIVE COMPONENTS GROUP, LLC;c/o MACMILLAN, SOBANSKI & TODD, LLC, ONE MARITIME PLAZA, FIFTH FLOOR, 720 WATER STREET, TOLEDO, OH, 43604, US

(73) Assignee: Lear Corporation

(21) Appl. No.: 11/525,444

(22) Filed: Sep. 22, 2006

(51) Int. Cl. B41M 5/40

(52) U.S. Cl. 264/46.4

(57) ABSTRACT

A method of forming a vehicle trim component includes providing a first component layer wherein the first component layer is formed from a first material and defines a substrate; forming a second component layer from a second material adjacent a portion of a surface of the substrate; and subsequently covering the substrate and second component layer with a third component layer formed from a third material, thereby forming a vehicle trim component.

### BACKGROUND

Various embodiments of a vehicle trim component are described herein. In particular, the embodiments described herein relate to an improved vehicle trim component and an improved method for forming such a vehicle trim component.

Motor vehicle interiors include may interior components made of panels. Examples of such interior components include interior door panels, instrument panels, consoles, and other interior trim panels.

The panels used to form the interior components typically comprise a relatively hard, rigid substrate, and a cover skin or layer. A soft padding may be disposed between at least a part of the substrate and the cover skin. The soft padding is typically foam, such as polyurethane foam, and is provided during a foam-in-place process. When foam is used, the panel is made by placing the cover skin layer and the substrate in the mold in a spaced apart arrangement, and then introducing foam into the mold. Upon curing, the foam secures the cover skin to the substrate.

FIG. 1 illustrates an example of a known panel 10. The panel includes a substrate 12, a foam layer 14, and cover skin 16. Many materials, such as leather, are used to form the cover skin 16. A leather cover skin 16 for example, may include two or more portions 16A and 16 B joined at a sewn seam 18. Such a seam must be sealed by a sealant, such as for example by a layer of Mylar® 20, to prevent foam from the foam layer 14 from leaking or seeping through the seam 18. The foam-in-place process and the application of a seam sealant add undesirable time and cost to the panel produced. It would therefore be desirable to provide an improved method of forming a vehicle trim component panel.

U.S. Pat. No. 6,991,841 discloses a process for forming a foam-in-place panel comprising placing a substrate and a cover layer in a mold and introducing foam between at least a portion of the substrate and the cover layer.

U.S. patent application Publication No. 2004/0056382 discloses a method of forming an instrument panel comprising a substrate and an outer layer in a two-step mold process.

### SUMMARY

The present application describes various embodiments of a vehicle trim component and its method of manufacture. One embodiment of the method of forming a vehicle trim component includes providing a first component layer formed from a first material and defining a substrate; forming a second component layer from a second material adjacent a portion of a surface of the substrate; and subsequently covering the substrate and second component layer with a third component layer formed from a third material, thereby forming a vehicle trim component. The second component layer may be formed from a second material relatively softer than the first material.

Another embodiment of the method of forming a vehicle trim component includes providing a first component layer formed from a first material and defining a substrate; providing a second component layer formed from a second material adjacent a portion of a surface of the substrate, wherein the second component layer has a channel formed in a surface thereof; providing a third component layer formed from at least two component panels of a third material, wherein the panels are joined together and define a seam therebetween; and subsequently positioning the seam within the channel and covering the substrate and second component layer with the third component layer, thereby forming a vehicle trim component. The second component layer may be formed from a second material relatively softer than the first material.

Other advantages of the vehicle trim component and its method of manufacture will become apparent to those skilled in the art from the following detailed description, when read in light of the accompanying drawings.

### BRIEF DESCRIPTION OF THE DRAWINGS

FIG. 1 is a schematic cross sectional view of a portion of a prior art vehicle trim panel.

FIG. 2 is a schematic perspective view of an embodiment of the vehicle trim component having substrate, a soft layer, and a wrapped skin layer.

FIG. 3 is a schematic cross sectional view in elevation illustrating a manufacturing step of an embodiment of the method of forming a vehicle trim component.

FIG. 4 is a schematic cross sectional view in elevation illustrating another manufacturing step in the embodiment of the method shown in FIG. 3.

FIG. 5 is a schematic cross sectional view in elevation illustrating another manufacturing step in the embodiment of the method shown in FIGS. 3 and 4.

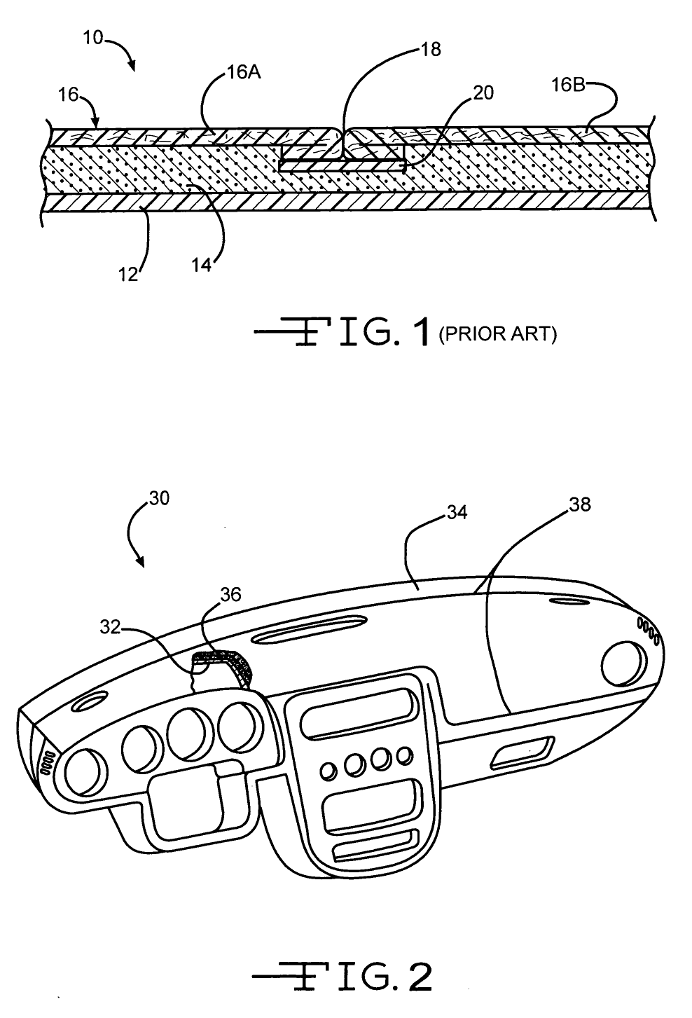

### DETAILED DESCRIPTION OF THE INVENTION

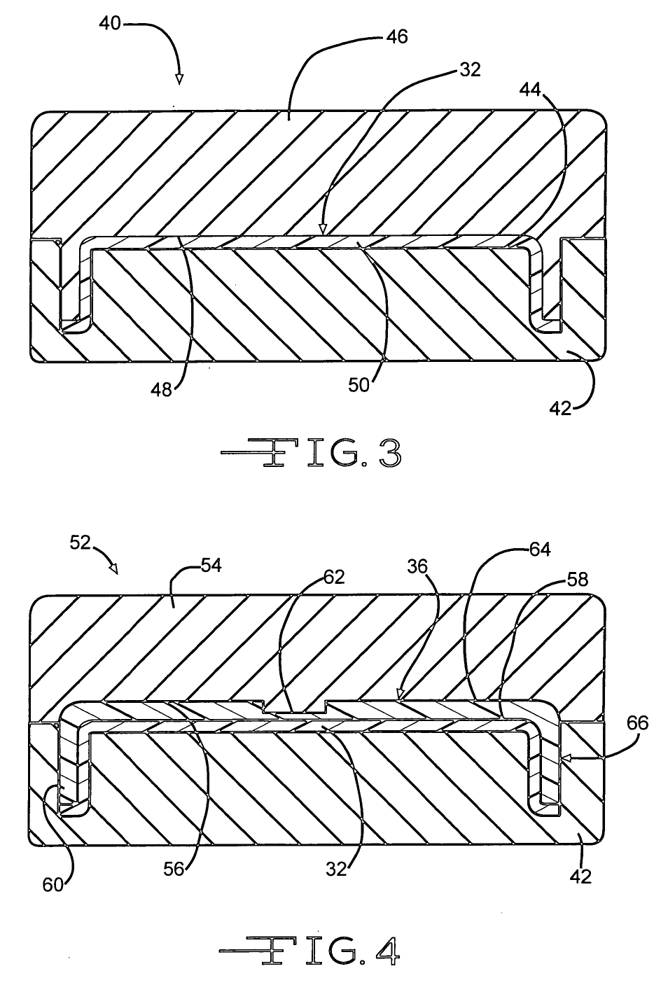

Referring now to the drawings, there is illustrated in FIG. 2, an instrument panel, indicated generally at 30, and manufactured according to the methods described herein below. The instrument panel 30 is an example of a trim component mounted to an interior cabin of a vehicle. It will be understood that the methods of manufacturing a trim component described herein and shown in FIGS. 3 through 5 is with respect to the instrument panel 30, the method may be practiced to manufacture any type of trim component or portion of a trim component. Examples of other trim components which can be manufactured according to the methods described herein include door panels, center consoles, overhead consoles, and other interior panels for covering the sides, ceilings, and/or vertical pillars of the frame members of the vehicle.

The illustrated panel 30 includes a substantially rigid first component layer or substrate 32, and a third component layer or cover skin 34 disposed over at least a portion of the substrate 32. The illustrated panel 30 further includes a second component layer 36 disposed between at least a portion of the substrate 32 and portions of the cover skin 34. Decorative stitched seams 38 may be provided in the cover skin 34.

The substrate 32, the cover skin 34, and the second component layer 36 may be made of any suitable material known to those of ordinary skill in the art. Examples of materials suitable for making the substrate include, but are not necessarily limited to, polypropylene (PP), polyethylene (PE), acrylonitrile butadiene styrene (ABS), thermoplastic elastomer (TPE), polycarbonate (PC), polycarbonate/acrylonitrile butadiene styrene (PC/ABS), styrene maleic anhydride (SMA), polyphenylene oxide (PPO), thermoplastic elastomer polyolefin (TPO), and nylon. The substrate 32 can be made by any suitable process such as injection molding or compression molding.

The second component layer 36 may be made from any suitable material known to those of ordinary skill in the art. Examples of materials suitable for making the second component layer 36 include, but are not necessarily limited to, TPO, PVC, urethane, PP, PC, ABS, polycarbonate ABS, SMA, PPO, nylon, and TPE. In the illustrated embodiment, the second component layer 36 is relatively softer than the substrate 32 and formed from TPE.

The cover skin 34 may be formed from any suitable material known to those of ordinary skill in the art. Examples of materials suitable for making the cover skin 34 include, but are not necessarily limited to, TPO, PVC, urethane, TPE, fabric, and leather. In the illustrated embodiment, cover skin 34 is formed from leather.

Referring now to FIG. 3, a first mold assembly for forming the trim panel 30 is indicated generally at 40. In the exemplary embodiment illustrated, the first mold assembly 40 includes a first mold portion 42 defining a first contour surface 44, and a second mold portion 46 defining a second contour surface 48. The first contour surface 44 and the second contour surface 48 define a first cavity 50 for receiving a first material which forms the substrate 32 of the panel 30. In the illustrated embodiment, the cavity 50 is shown with the first material of the substrate 32 therein.

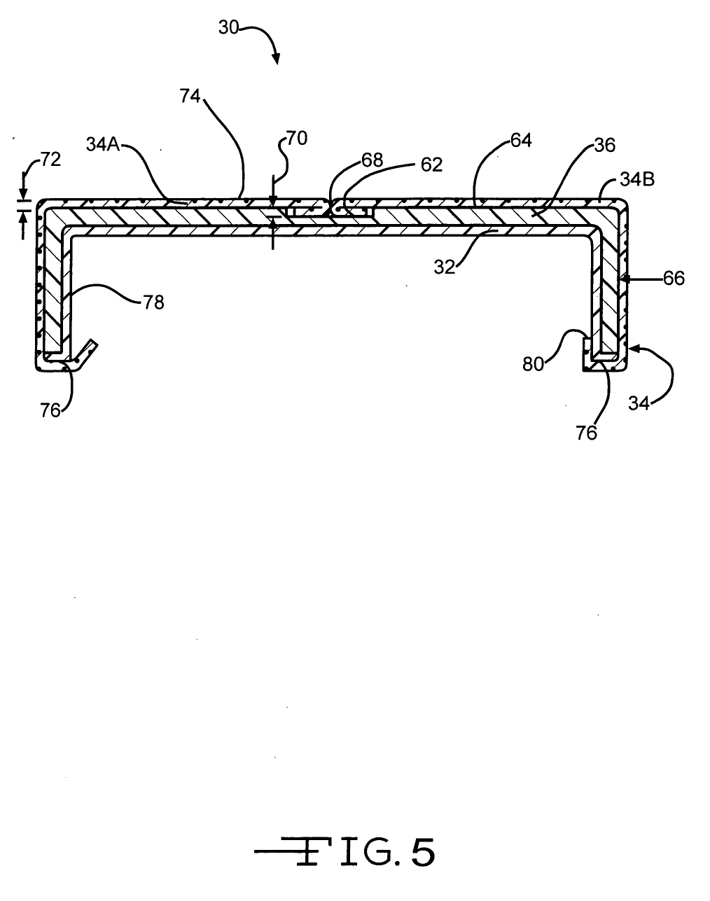

Referring to FIG. 4, a second mold assembly for forming the trim panel 30 is indicated generally at 52. In the exemplary embodiment illustrated, the second mold assembly 52 includes the first mold portion 42 and a third mold portion 54 defining a third contour surface 56. The third contour surface 56 and a surface 58 of the substrate 32 define a second cavity 60 for receiving a second material which forms the second component layer 36 of the panel 30. In the illustrated embodiment, the cavity 60 is shown with the second material of the second component layer 36 therein.

In a first embodiment of the method of forming the panel 30, the substrate 32 and the second component layer 36 are formed in a two-shot injection molding process. Any suitable two-shot injection molding process may be used. One example of such a suitable two-shot injection molding process is schematically illustrated in FIGS. 3 and 4.

The two-shot molding process may be accomplished by moving or rotating the first mold portion 42, such as in a rotational molding process. In such a rotational molding process, the substrate 32 (comprised of the first material) is first injection molded in the first cavity 50 the first mold assembly 40, as described herein. The first mold portion 42 containing the substrate 32 may be then rotated to a second position wherein the first mold portion 42 is joined with the third mold portion 54 to define the second cavity 60.

The second component layer 36 (comprised of the second material) is then injection molded in the second cavity 60, such that the second component layer 36 is formed adjacent at least a portion of the surface 58 of the substrate 32. In the embodiment of the second component layer 36 illustrated in FIG. 4, a channel 62 (the purpose of which will be explained in detail below) is formed in a surface 64 of the second component layer 36. If desired, the second component layer 36 may be formed without such a channel 62. The substrate 32 and the second component layer 36 thereby define a substrate subassembly 66.

In an alternate embodiment of the molding process, two separate molds could be used sequentially to form the substrate 32 and the second component layer 36. It will be understood that the substrate 32 and the second component layer 36 may be manufactured by any desired two-step molding process.

After the substrate subassembly 66 is formed, the substrate subassembly 66 is then covered by the third component layer or cover skin 34. In the illustrated embodiment the cover skin 34 is formed from leather. The illustrated cover skin 34 is further formed from at least two component panels 34A and 34B, joined together and defining a seam 68 therebetween. A portion of the cover skin 34 adjacent the seam 68 may have a thickness 70 greater relative to a thickness 72 of the remainder of the component panels 34A and 34B.

As best shown in FIG. 5, the cover skin 34 may then be wrapped about the substrate subassembly 66 such that the second component layer 36 is between the substrate 32 and the cover skin 34. In one embodiment of the method of forming the panel 30, the seam 68 is first positioned within the channel 62. If desired, the cover skin 34 may be attached or bonded to the surface 64 of the second component layer 36 with an adhesive.

Since the outer surface 74, or A-side surface, of the cover skin 34 is exposed to the interior cabin of the vehicle, it is desirable that the outer surface 74 have a finish and appearance that is tactilely and visually pleasing to a vehicle occupant. By positioning the seam 68 having the thickness 70 within the channel 62, the seam 68 of the panel 30 will not bulge undesirably outwardly (upwardly as viewed in FIG. 5) of the outer surface 74 of the cover skin 34.

Referring again to FIG. 5, the substrate subassembly 66 has a peripheral edge 76. In the illustrated embodiment of the method of forming the panel 30, the cover skin 34 is wrapped around at least a portion of the edge 76 and attached to the inner surface 78 of the substrate subassembly 66. The cover skin 34 may be attached to the inner surface 78 by any desired means, such as for example staples and/or an adhesive. It will be understood that during the wrapping step of the method described herein, the seam 68 will remain in the channel 62. It will be understood that the cover skin 34 may be bonded to the surface 64 and/or wrapped around the edge 76 prior to the seam 68 being positioned within the channel 62.

It will be further understood that the cover skin 34 need not be wrapped around the edge 76. For example, an edge 80 of the cover skin 34 may be positioned adjacent the edge 76 of the substrate subassembly 66.

The principle and mode of operation of the vehicle trim component and its method of manufacture have been described in its various embodiments. However, it should be noted that the vehicle trim component and its method of manufacture described herein may be practiced otherwise than as specifically illustrated and described without departing from its scope.

What is claimed is:

1. A method of forming a vehicle trim component, the method comprising the steps of:
a. providing a first component layer formed from a first material and defining a substrate;
b. forming a second component layer from a second material adjacent a portion of a surface of the substrate; and
c. subsequent to step (b), covering the substrate and second component layer with a third component layer formed from a third material, thereby forming a vehicle trim component.

2. The method according to claim 1, wherein the second component layer is formed from a second material relatively softer than the first material

3. The method according to claim 1, wherein the covering step further includes wrapping the third component layer about the substrate and second component layer such that the second component layer is between the substrate and the third component layer.

4. The method according to claim 3, wherein the covering step further includes attaching the third component layer to the substrate and second component layer.

5. The method according to claim 3, wherein the covering step further includes attaching the third component layer to the second component layer with an adhesive.

6. The method according to claim 1, wherein the step of forming the second component layer adjacent a portion of a surface of the substrate is performed in situ with the step of providing a first component layer.

7. The method according to claim 6, wherein the step of forming the second component layer adjacent a portion of a surface of the substrate includes forming the substrate and the second component layer in a two-shot molding process, the substrate and second component layer defining a substrate subassembly.

8. The method according to claim 1, wherein the substrate and second component layer define a substrate subassembly, the substrate subassembly having a peripheral edge, and wherein the covering step further includes wrapping the third component layer about the substrate subassembly such that the second component layer is between the substrate and the third component layer and the third component layer covers at least a portion of the edge, and attaching the third component layer to the substrate subassembly.

9. The method according to claim 1, further including the step of forming the third component layer from at least two component panels joined together and defining a seam therebetween.

10. The method according to claim 9, wherein the step of forming a second component layer includes forming a channel in a surface thereof.

11. The method according to claim 10, wherein the step of covering the substrate and second component layer with a third component layer further includes wrapping the third component layer about the substrate and second component layer such that the second component layer is between the substrate and the third component layer, and further includes positioning the seam within the channel.

12. The method according to claim 10, wherein the substrate and second component layer define a substrate subassembly, the substrate subassembly having a peripheral edge, and wherein the covering step further includes positioning the seam in the channel, wrapping the third component layer over the peripheral edge of the substrate subassembly and attaching a portion of the third component layer to the substrate subassembly, such that the seam remains in the channel.

13. The method according to claim 12, wherein the covering step further includes attaching the portion of the third component layer to the second component layer with an adhesive.

14. The method according to claim 12, wherein the covering step further includes attaching the portion of the third component layer is stapled to the substrate subassembly.

15. A method of forming a vehicle trim component, the method comprising the steps of:
a. providing a first component layer formed from a first material and defining a substrate;
b. providing a second component layer formed from a second material adjacent a portion of a surface of the substrate, the second component layer having a channel formed in a surface thereof;
c. providing a third component layer formed from at least two component panels of a third material, the panels joined together and defining a seam therebetween; and
d. subsequent to step (b), positioning the seam within the channel and covering the substrate and second component layer with the third component layer, thereby forming a vehicle trim component.

16. The method according to claim 15, wherein the second component layer is formed from a second material relatively softer than the first material.

17. The method according to claim 15, wherein the substrate and second component layer define a substrate subassembly, the substrate subassembly having a peripheral edge, and wherein step (d) further includes wrapping the third component layer about the substrate subassembly such that the second component layer is between the substrate and the third component layer.

18. The method according to claim 17, wherein the step (d) further includes attaching the third component layer to the substrate subassembly.

19. The method according to claim 18, wherein the step (d) further includes attaching the third component layer to the substrate subassembly with an adhesive.

20. The method according to claim 18, wherein the substrate subassembly has a peripheral edge, and wherein step (d) further includes wrapping the third component layer over the edge of the substrate subassembly and attaching a portion of the third component layer to the substrate subassembly such that the seam remains in the channel.
